(19) United States
(12) Patent Application Publication
(10) Pub. No.: US 2010/0255705 A1
(43) Pub. Date: Oct. 7, 2010

(54) ELECTRICAL CONNECTOR FOR FLEXIBLE PRINTED CIRCUIT BOARD

(76) Inventor: Kunihiro Higuchi, Osaka (JP)

Correspondence Address: HARRINGTON & SMITH, 4 RESEARCH DRIVE, Suite 202, SHELTON, CT, 06484-6212, US

(21) Appl. No.: 12/734,465

(22) PCT Filed: Nov. 27, 2008
(86) PCT No.: PCT/IB2008/055653

§ 371 Date: May 3, 2010

(30) Foreign Application Priority Data
Nov. 29, 2007 (IB) PCT/IB2007/055394

(51) Int. Cl. H01R 13/62

(52) U.S. Cl. 439/329

(57) ABSTRACT

An electrical connector includes a main body for receiving a flexible printed circuit board and a metal actuator which holds the flexible circuit board between the actuator and the support surface of the main body. Substantially L-shaped pivoting arms are provided to pivotally support the actuator on the main body. The actuator is capable of pivoting about the pivot and sliding in the direction of the longitudinal direction of the flexible circuit board joined to the main body. The actuator engages with the main body at a distal end portion of the actuator. An inclined plane on which the pivoting arm slides is provided on at least one side of the support surface contacting to the pivoting arm and beveled in the sliding direction of the pivoting arm.

### TECHNICAL FIELD

The present invention relates to an electrical connector, in particular, an electrical connector for connecting a flexible printed circuit board and the like.

### BACKGROUND ART

Recently, there is a need to decrease the size of connectors which make electrical connections and increase the density of electrodes in the connectors. In particular, there is a strong need due to the decrease in size and increase in density of modern electronic devices. Moreover, there is a need to facilitate electrical connection with simplified assembly steps.

Conventional flexible printed circuit board connectors are constituted by a part which is attached to a flexible circuit board and a part which is attached to a substrate. Such types of connectors have many parts, and it is difficult to make the connector compact.

Furthermore, in conventional connectors, in order to improve the reliability of the contact with the flexible printed circuit board, it is necessary to increase the strength of the parts, which may unavoidably increase the physical size of the connectors.

### SUMMARY OF INVENTION

An electrical connector according to the present invention is provided for connecting to a flexible printed circuit board. In one embodiment, the connector has a main body and an actuator coupled to the main body. The actuator is movable relative to the main body between an open position at which a flexible circuit board can be received by the main body, and a lock position at which, the flexible circuit board can be secured between the main body and the actuator, and an electrical connection can be established between the connector and the flexible circuit board. The main body has a support surface for receiving the flexible circuit board from a distal end thereof. The support surface has an electrode which contacts a conductor on one surface of the flexible circuit board. The actuator holds the flexible circuit board between the actuator and the support surface of the main body. Substantially L-shaped pivot support arms are provided which bear away from a planar part of the actuator after extending in the thickness direction of the actuator at a base end portion of the actuator. The actuator has pivots parallel to the width direction of the flexible circuit board at the front end of the pivot support arms. The main body has a pair of slots each receives a pivot of the actuator. The opening has a substantially rectangular shape taking the longitudinal direction of the flexible circuit board as the length thereof. The actuator is capable of rotating about the pivot and sliding in the direction of the longitudinal direction of the flexible circuit board joined to the main body. The actuator engages with the main body at a distal end portion of the actuator. An inclined surface on which the pivoting arm slides is provided on at least one side of the support surface contacting the pivot support arm and beveled in the sliding direction of the pivoting arm.

The inclined surface may have multiple angles of inclination. The actuator is a flat plate which overlaps a portion of the flexible circuit board. The actuator may have a boss which is raised in the thickness direction of the actuator on the portion which overlaps with the flexible circuit board.

The main body has side walls partially surrounding the support surface. The side walls forms a first slit into which of the distal end of the flexible circuit board may be inserted. An additional second slit, into which an end portion at the side near the distal end of a notch provided in the flexible circuit board is inserted, may also be formed at the side of the main body where the flexible circuit board extends. The support surface has a stopper for positioning the flexible circuit board in the surface direction by engaging with a notch provided in the flexible circuit board.

A protrusion is formed in each slot for joining by the pivot of the actuator, and the width of the opening is partially narrowed in the direction perpendicular to the support surface. The actuator may have an insulation coating on a surface that touches the flexible circuit board and/or at a surface on the rear side thereof.

In another embodiment, at least one center lock piece is provided at the side of the support surface where the flexible circuit board extends. The actuator has a center lock arm at a position corresponding to the center lock piece, and the center lock arm engages with the center lock piece. A center slope is provided at the edge of the center lock piece of a base end portion of the actuator.

The present invention provides a connector which is more compact than conventional connectors. In addition, the present invention provides a connector which can be easily and securely connected to a flexible circuit board without increasing the number of connector parts or complicating the connector structure.

### BRIEF DESCRIPTION OF THE DRAWINGS

FIG. 1 is a perspective view showing a connector according to a first embodiment of the present invention.

FIG. 2A is a cross sectional view along direction A-A of FIG. 1.

FIG. 2B is a partially enlarged view of FIG. 2A

FIG. 3A is a partial top view showing a flexible circuit board partially received by a connector shown in FIG. 1.

FIG. 3B is a partial top view showing a flexible circuit board partially received by a connector according to an alternative embodiment of the present invention.

FIG. 4 is a partial top view showing a flexible circuit board partially received by a connector according to another embodiment of the present invention.

FIG. 5A is a perspective view showing a connector of FIG. 1 in a state in which the actuator is at the close position.

FIG. 5B is a perspective view showing a connector of FIG. 1 in a state in which the actuator is at the lock position.

FIG. 6A is a cross sectional view of along direction B-B of FIG. 5A.

FIG. 6B is a diagram showing a cross section along direction C-C of FIG. 5B.

FIG. 7 is a perspective view showing a connector according to a further embodiment of the present invention.

FIG. 8 is a cross sectional view along direction D-D of FIG. 7 when the actuator is partially closed.

### DETAILED DESCRIPTION THE PREFERRED EMBODIMENTS

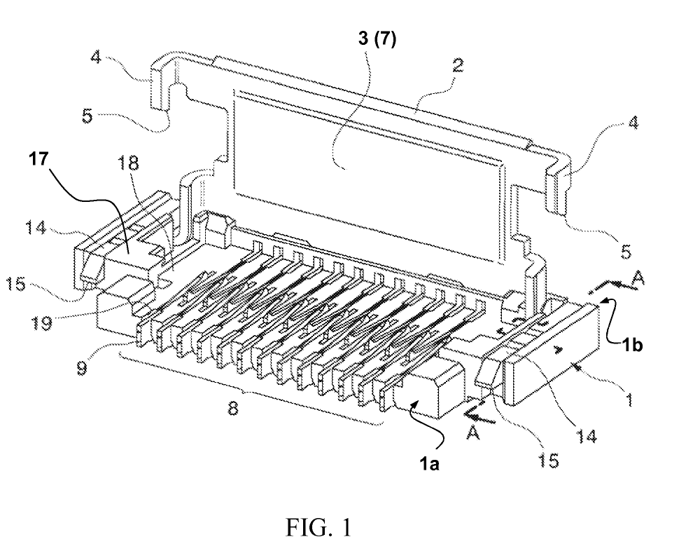

As shown in FIG. 1, an electrical connector according to one embodiment of the present invention has a main body 1 made of a formed resin, an actuator 2 which can be attached to and removed from main body 1, and lock pieces 14 which are mounted at both sides of main body 1. Main body 1 has a front end 1a and a back end 1b.

Main body 1 has a support surface 18 for receiving a distal end of a flexible circuit board 30. Terminal grooves 19 are formed on support surface 18, into which a plurality of terminals 9 constituting an electrode 8 are inserted. Terminals 9 slightly protrude out from terminal grooves 19 so as to contact flexible circuit board 30.

Main body 1 has side walls 17 which partially surrounds support surface 18. At corner portions of side walls 17, a first slit 12a, into which the corner portions of the distal end of flexible circuit board 30 can be inserted, is formed parallel to support surface 18.

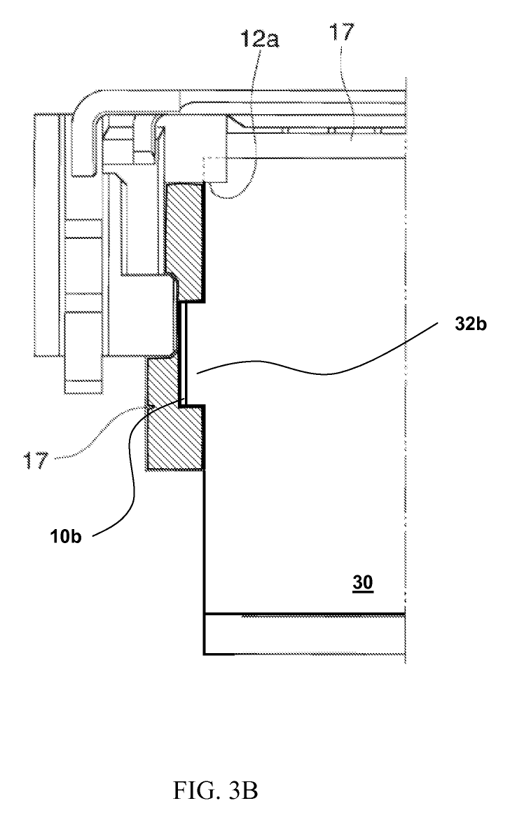

In an alternative embodiment as shown in FIG. 4, an additional second slit 12b, into which a corner portion of flexible circuit board 30 can be inserted, may also be formed on support surface 18.

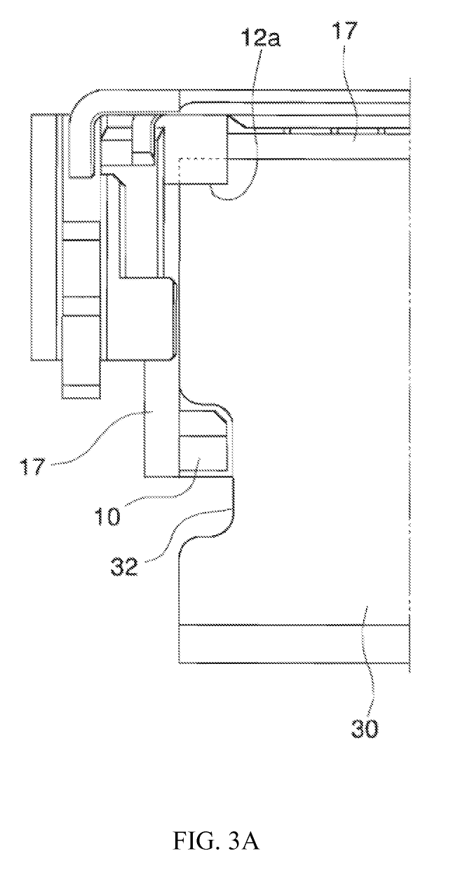

A stopper 10 which projects upward is formed on support surface 18. Stopper 10 positions flexible circuit board 30 in the surface direction by engaging a notch 32 provided on flexible circuit board 30. Alternatively, a lateral projection 32b may be formed on flexible circuit board 30, and a recess 10b for receiving lateral projection 32b may be formed on support surface 18 (FIG. 3B).

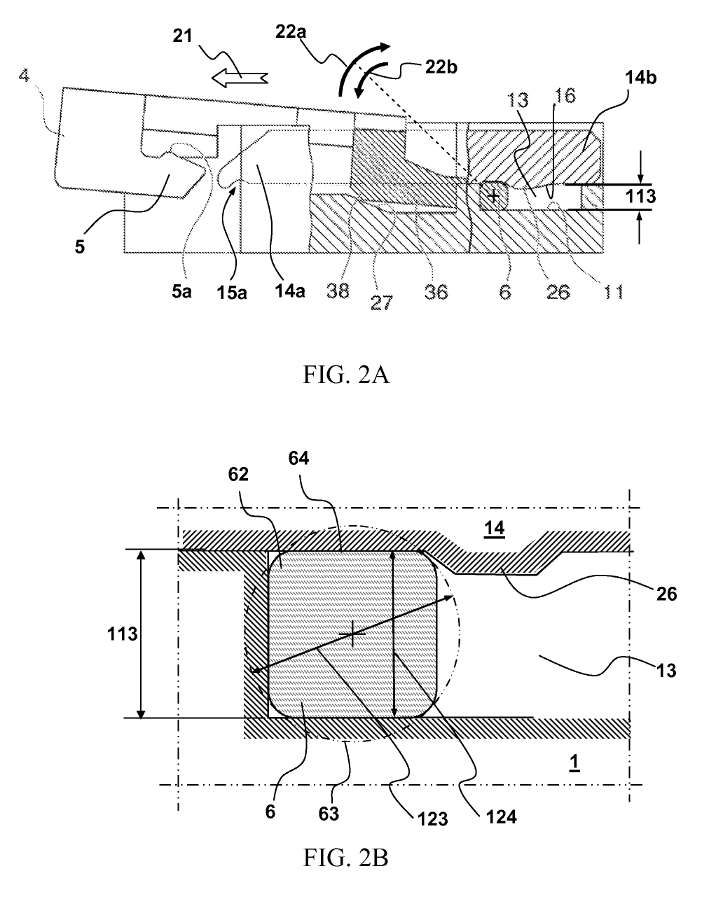

As shown in FIG. 2, an inclined surface 27 is formed on each side of support surface 18. Inclined surface 27 is lower adjacent to back end 1b and higher adjacent to front end 1a.

Lock pieces 14 are mounted at both sides of main body 1. Each lock piece 14 has a first end portion 14a extending towards front end 1a of main body 1 and a second end portion 14b extending towards back end 1b of main body 1. Second end portion 14b and main body 1 together form a substantially rectangular recess or slot 13, having an upper edge 16 which is part of lock piece 14 and a lower edge 11, which is part of main body 1.

A protrusion 26 is formed on upper edge 16 and projects inwardly into slot 13. The width 113 of slot 13 is partially narrowed at areas where protrusion 26 is formed.

Actuator 2 is generally of a flat plate shape which has a cover portion that overlaps flexible circuit board 30. The cover portion has a boss 3 which is raised in the thickness direction of actuator 2. A coating layer 7 made of an insulating resin is coated over boss 3, for contacting flexible circuit board 30.

Each side edge portion of actuator 2 has a lock arm 4 which extends in the thickness direction of actuator 2. At the distal end portion of each lock arm 4, there is formed a latch 5 for engaging first end portion 14a. Latch 5 may have a projection 5a projecting perpendicularly with respect to lock arm 4 and in a direction parallel to the cover portion of actuator 2. First end portion 14a may have a notch 15a to engage protection 5a, so as to strengthen the latching effect between latch 5 and first end portion 14a.

Base end portion of actuator 2 has a substantially L-shaped support arm 36 formed at each side edge, which extends from the base end portion of actuator 2 in the thickness direction of actuator 2, then bent at a right angle at a shoulder 38 and extends along a direction parallel to the cover portion of actuator 2. A distal end of each support arm 36 has a pivot 6 which is parallel to the cover portion of actuator 2.

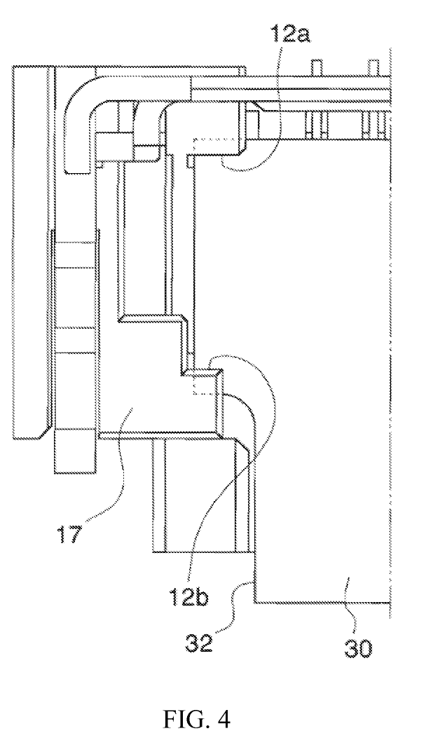

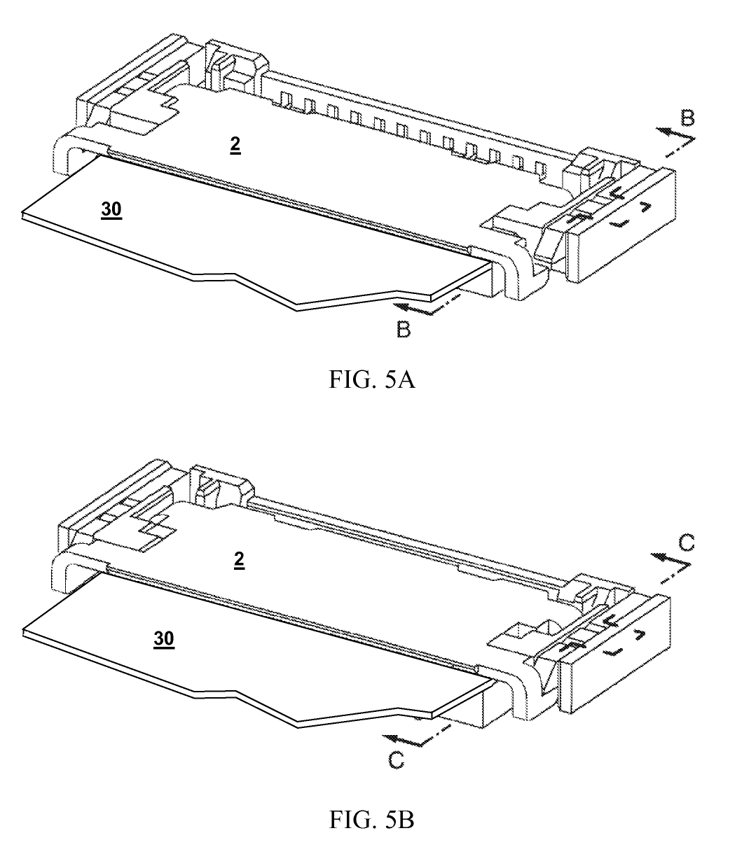

Actuator 2 is attached to main body 1 with each pivot 6 inserted into a corresponding slot 13. Actuator 2 is therefore rotatable with respect to main body 1 about pivots 6 between an open position (FIG. 1) and a close position (FIG. 5A). In addition, actuator 2 is slidable relative to main body 1, with pivots 6 sliding along slots 13, between the close position (FIG. 5A) and a lock position (FIG. 5B).

When actuator 2 is operated to slide along direction 21, i.e. against the insertion direction of flexible circuit board 30, shoulder 38 is brought into contact with the lower end of inclined surface 27. When actuator 2 moves further along direction 21, shoulder 38 climbs upward along inclined surface 27. Actuator 2 therefore rotates, shown in FIG. 2A, along clockwise direction 22a about pivots 6 and is lifted up from the main body 1, to the open position.

When actuator 2 is moving toward the open position, pivots 6 act against and passes over protrusion 26, by forcing lock piece 14 to deform upward. Thereafter, actuator 2 will stop sliding at the end of slot 13 adjacent to front end 1a of main body 1, and rotates towards the open position.

Each pivot 6 has a chamfered or fillet polygonal cross-section, for example a chamfered or fillet square-shaped cross section having four edge portions 62 and four flat sides 64. The diameter 123 of the circumscribed circle 63 of the square-shaped cross section of pivot 6, i.e. the distance between diagonal edge portions 62, is larger than the width 113 of slot 13. The height 124 of pivot 6 (i.e. the distance between opposite flat sides 64) is about the same size as width 113 of slot 13. This allows pivot 6 to slide along slot 13, and pass over protrusion 26 by resiliently deforming lock pieces 14. During rotation of actuator 2 to the open position, edge portion 62 acts against lock piece 14 and overcome the resilient force exerted by lock piece 14, to allow further rotation of pivot 6. When pivots 6 rotates about 90 degree along direction 22a, edge portions 62 pass over the maximum gap distance of slot 13 caused by the upward deformation of lock piece 4. Lock piece 14 is then allowed to resume its original position, and rest on flat portion 64. Without external force, e.g. one applied by a user, lock piece 14 will not be deformed but remain in contact with flat side 64, with a gap width of slot 13 about the same as height 124. Since diameter 123 is greater than width 113, lock piece 14 will act against edge portion 62 to prevent reverse rotation (along counterclockwise direction 22b) of actuator 2. Accordingly, actuator 2 can be kept at the open position, as shown in FIG. 1.

While actuator 2 is at the open position, flexible circuit board 30 may be attached to the connector, by inserting the distal end of flexible circuit board 30 into slit 12a and/or slit 12b. As a result, flexible circuit board 30 is partially attached to the connector.

When flexible circuit board 30 is at this position, stopper 10 engages with notch 32 formed on flexible circuit board 30. As a result, flexible circuit board 30 is positioned on support surface 18 and is prevented from being pulled out in the longitudinal direction.

Actuator 2 can then be rotated, by an external force applied thereon, about pivots 6 along counterclockwise direction 22b (FIG. 2A). Edge portion 62 can now deform lock piece 14 upward, actuator 2 will rotate to the close position. Actuator 2 further slides towards back end 1b of main body 1, with shoulder 38 moving to the lower portion along inclined surface 27. Protrusion 26 is resiliently deformed upward again, which allows pivots 6 to pass over. At this position, actuator 2 holds flexible circuit board 30 against support surface 18, as shown in FIG. 5A.

Thereafter, latch 5 of actuator 2 is positioned underneath first end portion 14a of lock piece 14, and with projection 5a received by notch 15a, by sliding the actuator 2 to back end 1b of main body 1. Actuator 2 is now at the locked position at which flexible circuit board 30 is fixedly connected to the connector between support surface 18 and actuator 2, as shown in FIG. 5B.

Inclined surface 27 may have various types of surface profiles. For example, the angle of inclined surface 27 may vary, i.e. inclined surface 27 may have a curved profile. Under this configuration, the force applied on actuator 2 is variable by arbitrarily changing the angles of inclined surface 27. Therefore, opening and/or closing of actuator 2 can function more easily and effectively.

In one embodiment, the angle which is near the base end portion of the actuator 2 may be small and the angle which is near the distal end portion of the actuator 2 may be large. Accordingly, the force applied on actuator 2 for disengaging from main body 1 can be decreased. Alternatively, the angle which is near the base end portion of actuator 2 may be large, the force applied on actuator 2 for disengaging from main body 1 can be increased. Actuator 2 and main body 1 can be latched together more securely.

The force applied on actuator 2 can be changed in incremental steps by changing the angle in incremental steps. Alternatively, the force applied on actuator 2 can be changed continuously by making the inclined surface 27 a smooth curved profile.

Stopper 10 has an additional function of detecting an improper insertion position of flexible circuit board 30. In the event that flexible circuit board 30 is not properly inserted into the connector, notch 32 cannot be positioned properly with the stopper 10, i.e. flexible circuit board 30 will ride on stopper 10, and the actuator 2 will therefore not be able to close. Improper insertion state of flexible circuit board 30 can be detected.

In another embodiment, shown in FIG. 3B, a lateral projection 32b is formed on flexible circuit board 30, and a recess 10b is formed on support surface 18. Recess 10b can engage with lateral projection 32b to prevent flexible circuit board 30 from pulling out from main body 1. This embodiment provides an alternative solution, which may be suitable for a flexible circuit board which does not have enough width to form a notch.

Actuator 2 may be electrically connected to flexible circuit board 30 by removing a portion of insulation coating 7. By electrically connecting a shield or grounding wire of flexible circuit board 30 to the actuator 2, a shield or ground function can be achieved.

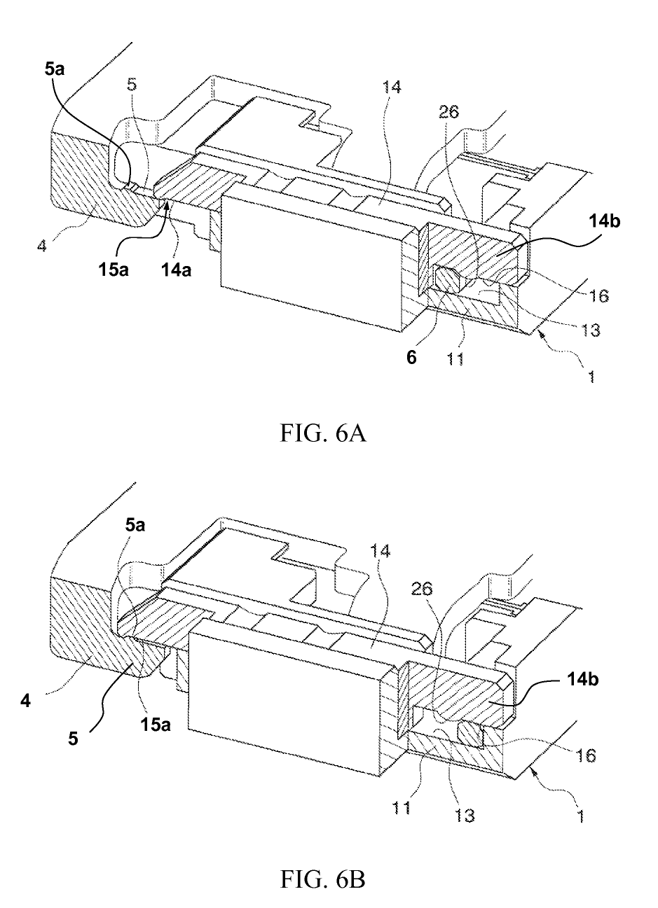

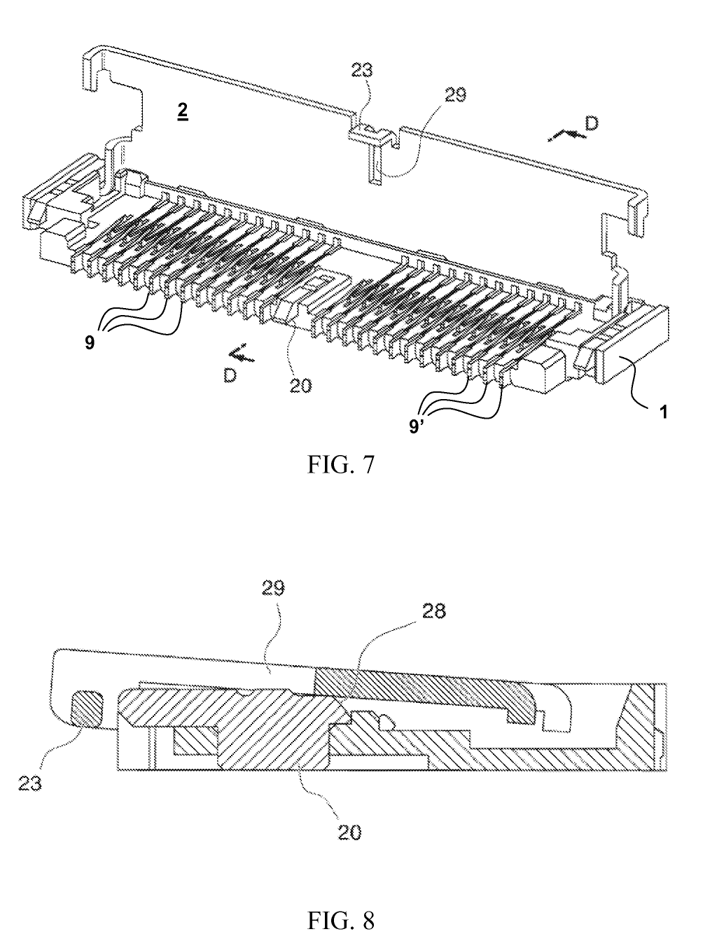

FIG. 7 shows a further embodiment of the present invention. In this embodiment, like reference symbols refer to like features shared with previous embodiment shown in FIG. 1, and an explanation thereof is omitted.

In this embodiment, more terminals 9′ are provided. A center lock piece 20 is formed at the center portion of main body 1, and a center lock arm 23 is formed on actuator 2 corresponding to center lock piece 20. A relief opening 29 is formed in the planar portion of actuator 2 in order to prevent interference between center lock piece 20 and actuator 2 when they have been connected.

A center slope 28 which has a same surface profile as inclined surface 27 is formed at the end portion of center lock piece 20, which is near the base end portion of actuator 2.

At a position of the distal end portion of the actuator 2 corresponding to center lock piece 20, the center lock arm 23, which is substantially U-shaped, is provided and extends in the plate thickness direction of actuator 2.

To connect a flexible circuit board to the connector, firstly, actuator 2 is pulled out in the same way as that described in previous embodiments. When actuator 2 slides, each lock arm is disengaged. Shoulder 38 of the actuator 2 then climbs along inclined surface 27. At the same time, the end portion of relief opening 29 also climbs along center slope 28.

After a flexible circuit board is inserted into main body 1, actuator 2 is pivoted to the closed position, and slide backward. The end portion of relief opening 29 is made to descend along center slope 28. Actuator 2 slides further in the same direction to the locked position at which, center lock arm 23 is made to engage with center lock 20.

With the increase in the number of terminals, actuator 2 may be pushed upward and has a tendency to be bent by the reaction force of the terminals. However, due to the action of the center lock, the deformation of the actuator 2 can be restricted within an acceptable limit. In this embodiment, although the center lock is only provided at one location in the center portion, more than one center locks may be provided at several locations in accordance with need.

It should be appreciated that while the inclined surfaces for lifting up actuator 2 are formed on both the support surfaces as well as the center lock portion 20, a connector may have only one inclined surface which works in the same effective manner.

### LIST OF REFERENCE SYMBOLS

1 main body
1a front end
1b back end
2 actuator
3 boss
4 lock arm
5 latch
5a projection
6 pivot
7 insulating coating
62 edge portion
63 circumscribed circle
123 diameter of circumscribed circle
64 flat side
124 height
8 electrode
9 terminals
9′ terminals
10 stopper
10b recess
11 lower edge
12a first slit
12b second slit
13 slot
113 width
14 lock piece
14a first end portion
14b second end portion
15a notch
16 upper edge
17 side wall
18 support surface
19 terminal grooves
20 center lock piece
21 direction against insertion direction
22a clockwise direction
22b counter clockwise direction
23 center lock arm
26 protrusion
27 inclined surface
28 center slope
29 relief opening
30 flexible circuit board
32 notch
32b lateral projection
36 support arm
38 shoulder

1. An electrical connector comprising:
a main body having a support surface for receiving a portion of a flexible circuit board;
contact terminals disposed in the main body for electrically contacting the flexible circuit board;
an actuator movably attached to the main body,
wherein the actuator is rotatable relative to the main body between an open position at which the flexible circuit board is receivable by the main body and a close position at which the flexible circuit board is held to the main body; and
wherein the actuator is slidable relative to the main body between the close position and a lock position at which rotation of the actuator is prevented and that the flexible circuit board is fixed to the main body between the actuator and the support surface.

2. The electrical connector of claim 1, further comprising a pair of lock pieces fixed to the main body, each lock piece has a first end portion extending towards a front end of the main body and a second end portion extending towards a back end of the main body; wherein the second end portion and the main body form a slot located at a side portion of the main body, wherein the actuator having a planar portion, a pair of support arms each extending perpendicularly from an edge of the planar portion and a pair of pivots each extending outwardly from a corresponding support arm, each pivot is received in a corresponding slot.

3. The electrical connector of claim 2, wherein the actuator further comprising a latch member which engages with the first end portion when the actuator moves from the close position to the lock position.

4. The electrical connector of claim 2, wherein the main body further comprising an inclined surface to support the support arms when the actuator moves from the lock position to the close position.

5. The electrical connector of claim 4, wherein the inclined plane has multiple angles of inclination.

6. The electrical connector of claim 2, wherein the actuator has a boss raised in a thickness direction of the planar portion.

7. The electrical connector of claim 2, wherein the slot has a protrusion projecting inwardly whereby a width of the slot is partially narrowed in the direction perpendicular to the support surface.

8. The electrical connector of claim 1, wherein the main body has side walls partially surrounding the support surface, the side walls forming a first slit for receiving a distal end of said flexible circuit board.

9. The electrical connector of claim 1, the side walls forming a second slit into which an end portion at the side near the distal end of a notch provided in the flexible circuit board is inserted.

10. The electrical connector of claim 1, wherein the support surface has a stopper for positioning the flexible circuit board in the surface direction by engaging with a notch provided in the flexible circuit board.

11. The electrical connector of claim 1, wherein the actuator has an insulation coating on a surface that contacts the flexible circuit board.

12. The electrical connector of claim 1, wherein at least one center lock portion is provided on the side of the support surface where the flexible circuit board extends, and wherein the actuator has a center lock arm which corresponds to said center lock portion, and the center lock arm is engageable with the center lock portion.

13. The electrical connector of claim 12, wherein a center slope is provided at the edge of the center lock portion of a base end portion of said actuator.

14. An electrical connector to be attached to an end portion of a planar flexible circuit board comprising:
a main body having a support surface on which is placed a portion of said flexible circuit board of a predetermined length from a distal end thereof, the support surface provided with an electrode which contacts a conductor on one surface of said flexible circuit board; and
a metal actuator which holds said flexible circuit board between said actuator and the support surface of the main body, wherein
substantially L-shaped support arms are provided which bear away from a planar part of said actuator after extending in the thickness direction of said actuator at a base end portion of said actuator,
said actuator has pivots parallel to the width direction of said flexible circuit board at the front end of said support arms,
a slot for joining by said pivot of said actuator forms a substantially rectangular shape taking the longitudinal direction of said flexible circuit board as the length thereof,
said actuator is pivotable around said pivot and slidable in the direction of the longitudinal direction of said flexible circuit board joined to said main body, and said actuator engages with said main body at a distal end portion of said actuator,
characterized in that an inclined plane on which said pivoting arm slides is provided on at least one side of said support surface contacting said pivoting arm and beveled in the sliding direction of said pivotal arm.

15. An electrical connector according to claim 14, characterized in that said inclined plane has multiple angles of inclination.

16. An electrical connector according to claim 14, characterized in that said actuator is a flat plate which overlaps with said flexible circuit board of a predetermined length.

17. An electrical connector according to claim 14, characterized in that said actuator is provided with a boss which is raised in the thickness direction of said actuator on the portion which overlaps with said flexible circuit board.

18. An electrical connector of claim 14, characterized in that said main body is provided with side walls which surround said support surface, the side walls forming a first slit for insertion of the distal end of said flexible circuit board.

19. An electrical connector of claim 18, characterized in that a second slit, into which an end portion at the side near the distal end of a notch provided in said flexible circuit board is inserted, is formed at the side of said main body where said flexible circuit board extends.

20. An electrical connector of claim 14, characterized in that said support surface has a stopper for positioning said flexible circuit board in the surface direction by engaging with a notch provided in said flexible circuit board.

21. An electrical connector of claim 14, characterized in that a protrusion is provided in said slot for joining by said pivot of said actuator and the width of said opening is partially narrowed in the direction perpendicular to said support surface.

22. An electrical connector of claim 14, characterized in that said actuator is provided with an insulation coating on a surface that touches said flexible circuit board and/or at a surface on the rear side thereof.

23. An electrical connector of claim 14, characterized in that at least one center lock portion is provided on the side of said support surface where said flexible circuit board extends, a center lock arm is provided on said actuator which corresponds to said center lock portion, and said center lock arm is engaged with said center lock portion.

24. An electrical connector of claim 23, characterized in that a center slope is provided at the edge of said center lock portion of a base end portion of said actuator.
